(19) United States
(12) Patent Application Publication
(10) Pub. No.: US 2010/0277269 A1
(43) Pub. Date: Nov. 4, 2010

(54) STRUCTURE OF BASE OF FUSE

(76) Inventor: CHUN-CHANG YEN, Hsichih City (TW)

Correspondence Address: LEONG C LEI, PMB # 1008, 1867 YGNACIO VALLEY ROAD, WALNUT CREEK, CA, 94598, US

(21) Appl. No.: 12/431,770

(22) Filed: Apr. 29, 2009

(51) Int. Cl. H01H 37/04

(52) U.S. Cl. 337/414

(57) ABSTRACT

A fuse includes a base. The base includes a body and two leads. The body has two side portions each forming a hole extending through top and bottom faces of the body and having a lower end forming a diverging lead-in opening. Each lead has a top end and forms a flattened fixing portion. The lead can be fit into a respective fitting hole of the body through the lead-in opening in an automatic manner with machines and can then be fixed in the fitting hole with the fixing portion. The top end of the lead projects beyond the top face of the fitting hole to serve as a terminal that can then be flattened. In the way, human errors can be eliminated in assembling the lead and the body and the assembling can be done with enhanced precision.

### (a) TECHNICAL FIELD OF THE INVENTION

The present invention generally relates to improvement of fuse structure, and particularly to an elaborate modification to improve the combination of a base body and leads that are constituent components of a fuse base in order to make the combination more precise.

### (b) DESCRIPTION OF THE PRIOR ART

The type of fuse that is discussed here in the application is generally of a rectangular or circular configuration as shown in FIGS. 1 and 2 of the attached drawings. Also referring to FIG. 3, this type of fuse comprises a base 1, which is comprised of a body 10 and two leads 20 extending through the body 10, and a cover 2. Tips of the two leads 20 extending through the body 10 are flattened to form terminals 22, between which a fusible filament 30 is interposed. The cover 2 is put over and completely encloses the base body 10. As shown in FIGS. 4 and 5, structural details of the conventional fuse base 1 are illustrated, and manufacturing is performed by first providing two leads 20 of substantially the same length and flattening an end of each lead 20 to make a terminal 22. Each lead 20 is further processed to form a deformed flat section or texture 21 at a location close to the terminal 22 thereof. The two leads 20 are then manually positioned into a mold for making the body 10 to carry out injection molding and thus completing the manufacturing of the base 1. Since the leads 20 are positioned in the mold in a manual manner, human errors inevitably occur, leading to skewing or non-corresponding lengths of the leads. Consequently, flaw or damage products may be of a high percentage. This certainly needs to improve.

### SUMMARY OF THE INVENTION

The present invention aims to provide a structure of a base of a fuse that facilitates the assembling thereof. As shown in FIG. 6, the fuse base, generally designated at 1, comprises a body 10 and two leads 20. The present invention features fitting holes 11 extending through top and bottom faces of the body 10 in opposite side portions thereof. The fitting holes 11 have a diverging lead-in opening at the lower end thereof. Each lead 20 is formed with a flattened fixing portion 21 at a location close to a top terminal end of the lead 20. The lead 20 can then be fit into the fitting hole of the base body with the terminal end thereof in an automatic manner through proper mechanical facility.

Thus, the objective of the present invention is to provide a fuse that has a base comprised of a body, preferably made of insulation material, and two leads, which are electrically conductive, and the base is constructed in such a way that assembling the lead to the body can be done in a human error free and precision enhanced manner.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a conventional rectangular fuse device.

FIG. 2 is a perspective view showing a conventional circular fuse device.

FIG. 3 is a schematic view showing inside structure of the conventional fuse device.

FIGS. 4 and 5 show structural details of a base of the conventional fuse device.

FIG. 6 is an exploded view of a base of a fuse in accordance with the present invention.

FIGS. 7 and 8 show structural details of the base of the fuse of the present invention.

FIG. 9 is a cross-sectional view of the base of the fuse of the present invention.

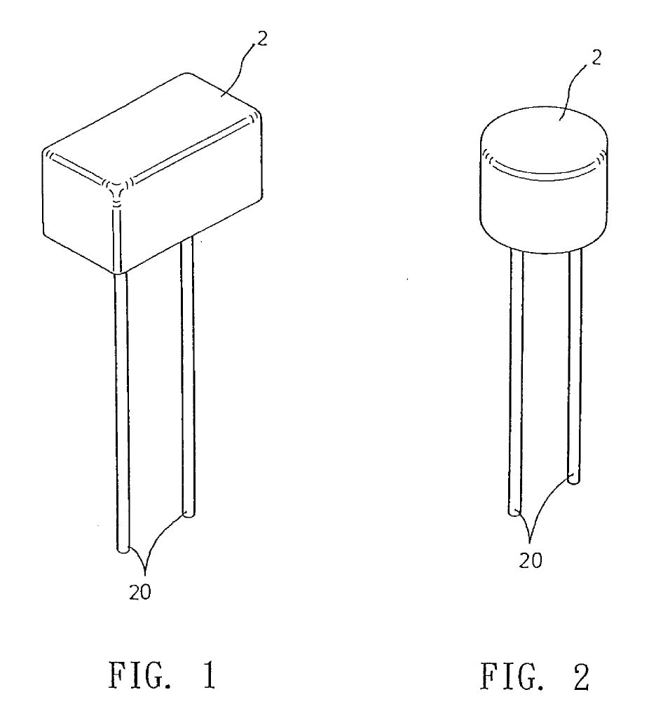

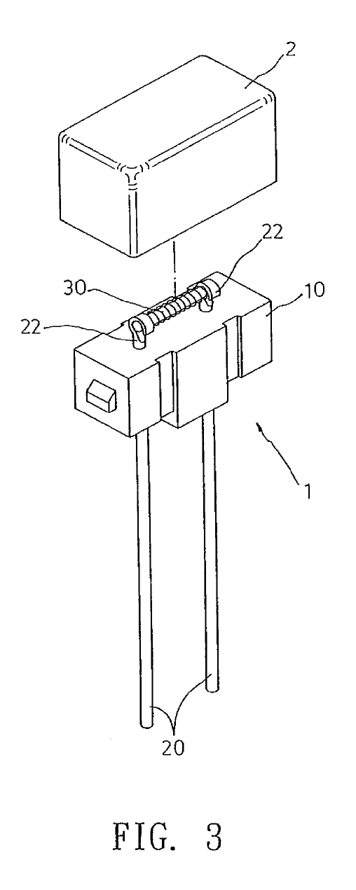

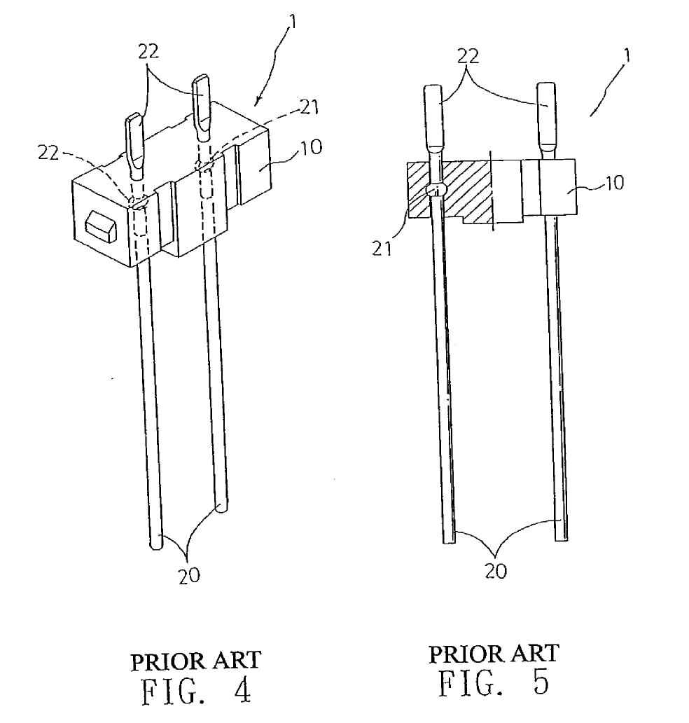

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

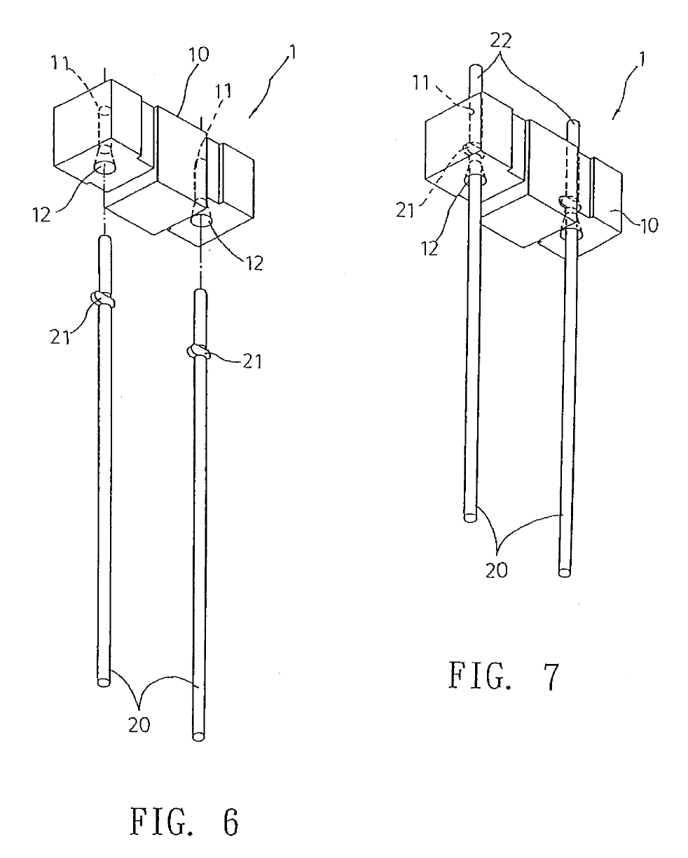

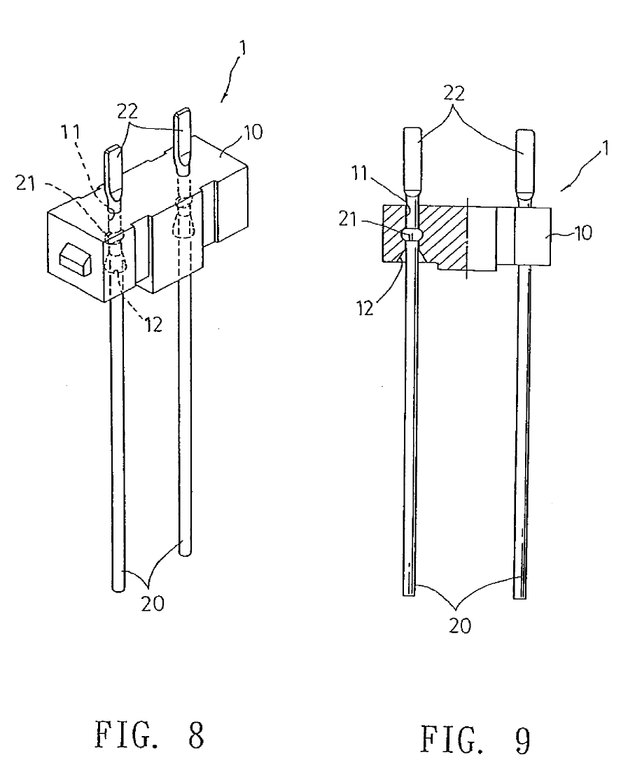

With reference to FIGS. 6-9, the present invention provides a fuse having a base, generally designated at 1. The fuse base 1 is comprised of a body 10 and two leads 20. The body 10 has left and right side portions each forming a fitting hole 11 extending through both top and bottom faces of the body 10. The fitting hole 11 has a lower end that forms a diverging lead-in opening 12. Each lead 20 has a top end and each lead 20 forms a flattened fixing portion or texture 21 at a location close to the top end. The lead 20 with this configuration is allowed to fit into the fitting hole 11 of the body 10 through the lead-in opening 12 in an automatic manner with proper machines. The lead 20 is fixed inside the fitting hole 11 by the fixing portion or texture 21 engaging the inside wall of the fitting hole and the top end of the lead 20 projects beyond the top face of the fitting hole 11 to serve as a terminal 22 that can then be flattened. The above arrangement can eliminate potential human errors in assembling the body and the leads and as a consequence, flaws and damages of the final products can be reduced.

Further, the arrangement made in accordance with the present invention is also applicable to other electric products. In other words, positioning of parts realized through a diverging lead-in opening can used in positioning and fixing of other type of electrical plug-in or fitting parts.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A fuse base comprising a body and two leads, the body having two side portions each forming a hole extending through top and bottom faces of the body and having a lower end forming a diverging lead-in opening, each lead having a top end and forming a flattened fixing portion, so as to allow the lead to be fit into a respective fitting hole of the body through the lead-in opening in an automatic manner with machines and fixed in the fitting hole with the fixing portion.

2. The fuse base according to claim 1, wherein the base has a configuration that is rectangular, circular, or other geometric shape.

3. The fuse base according to claim 1, wherein the diverging lead-in opening is applicable to receiving and fixing other electric plug-in parts.
